(19) United States
(12) Patent Application Publication
(10) Pub. No.: US 2018/0277138 A1
(43) Pub. Date: Sep. 27, 2018

(54) METHOD AND ELECTRONIC DEVICE FOR OUTPUTTING SIGNAL WITH ADJUSTED WIND SOUND

(71) Applicant: SAMSUNG ELECTRONICS CO., LTD., Suwon-si (KR)

(72) Inventors: Vadim KUDRYAVTSEV, Suwon-si (KR); Gunwoo LEE, Suwon-si (KR); Byeongjun KIM, Gwangmyeong-si (KR); Jaehyun KIM, Yongin-si (KR)

(21) Appl. No.: 15/928,134

(22) Filed: Mar. 22, 2018

(30) Foreign Application Priority Data
Mar. 24, 2017 (KR) 10-2017-0037545

(51) Int. Cl. G10L 21/0232; H04R 29/00; G10L 25/51; G10L 25/30

(52) U.S. Cl. CPC G10L 21/0232; H04R 29/004; H04R 2410/07; G10L 25/30; G10L 25/51

(57) ABSTRACT

An electronic device and method for cancelling wind noise from a sound signal input through a microphone is provided. An electronic device of the present disclosure includes an input device comprising input circuitry, an output device comprising output circuitry, and a processor configured to control the input device to acquire a first signal corresponding to external sound of the electronic device, to generate a second signal by delaying the first signal for a predetermined amount of time, to detect a third signal corresponding to the wind sound in the first signal using a predetermined detection method based on the first and second signals, and to control the output device to output a fourth signal obtained by controlling the third signal in the first signal.

### CROSS-REFERENCE TO RELATED APPLICATION

This application is based on and claims priority under 35 U.S.C. § 119 to Korean Patent Application No. 10-2017-0037545 filed in the Korean Intellectual Property Office on Mar. 24, 2017, the disclosure of which is incorporated by reference herein in its entirety.

### TECHNICAL FIELD

The present disclosure relates generally to an electronic device and, for example, to an electronic device and method for cancelling wind noise from a sound signal input or received through a microphone.

### BACKGROUND

In line with the advance of mobile communication and hardware and software technologies, portable electronic devices represented by smartphones have evolved to incorporate various features. Recently introduced smartphones are equipped with a microphone for collecting sounds including a user's voice.

In the case of using the microphone embedded in an electronic device to collect a user's voice, voice and noise are picked up simultaneously. In particular, wind noise is everywhere and contributes to sound quality deterioration.

In order to minimize/reduce wind noise, a wind-screen has been placed over the microphone and the microphone has been designed to have a structure for suppressing wind-noise. However, in view of a compact design such a hardware approach is not appropriate because of an increase in the physical size of the electronic device and limits on the freedom of design.

Also a software-based wind noise detection technique has been used, but such a software approach has the drawbacks of sound quality distortion, requirement of multiple microphones, and increase of computation amount.

### SUMMARY

The present disclosure addresses the above problems and provides a wind noise cancellation method and device that is capable of detecting wind noise using a low computation amount by processing a sound signal collected by a microphone in the time domain.

In accordance with an example aspect of the present disclosure, an electronic device is provided. The electronic device includes an input device comprising input circuitry, an output device comprising output circuitry, and a processor configured to control the input device to acquire a first signal corresponding to external sound of the electronic device, to generate a second signal by delaying the first signal for a predetermined amount of time, to detect a third signal corresponding to a wind sound in the first signal using a predetermined detection method based on the first and second signals, and to control the output device to output a fourth signal obtained by controlling the third signal in the first signal.

In accordance with another example aspect of the present disclosure, a wind sound-controlled signal output method of an electronic device is provided. The wind sound-controlled signal output method includes acquiring a first signal corresponding to external sound of the electronic device, generating a second signal by delaying the first signal for a predetermined amount of time, detecting a third signal corresponding to a wind sound in the first signal using a predetermined detection method based on the first and second signals, and outputting a fourth signal obtained by controlling the third signal in the first signal.

### BRIEF DESCRIPTION OF THE DRAWINGS

The above and/or other aspects, features and attendant advantages of the present disclosure will be more apparent and readily appreciated from the following detailed description, taken in conjunction with the accompanying drawings, in which like reference numerals refer to like elements, and wherein:

FIG. 1 is a block diagram illustrating an example electronic apparatus in a network environment according to an example embodiment of the present disclosure;

FIG. 2 is a block diagram illustrating an example electronic device according to an example embodiment of the present disclosure;

FIG. 3 is a block diagram illustrating an example configuration of a programming module according to an example embodiment of the present disclosure;

FIG. 4 is a block diagram illustrating an example configuration of an electronic device according to an example embodiment of the present disclosure;

FIG. 5 is a graph illustrating an example waveform of a sound signal for examining a sound noise cancellation method according to an example embodiment of the present disclosure;

FIG. 6 is a block diagram illustrating an example operation of a processor according to an example embodiment of the present disclosure;

FIG. 7 is a diagram illustrating an example process of detecting wind noise in a sound signal according to various example embodiments of the present disclosure;

FIG. 8 is a graph illustrating an example waveform of a sound signal including wind noise for explaining an example wind noise detection method according to various example embodiments of the present disclosure;

FIG. 9 is a diagram illustrating an example single channel wind noise detection method and apparatus according to various example embodiments of the present disclosure;

FIG. 10 is a diagram illustrating an example multi-channel wind noise detection method of an electronic device according to various example embodiments of the present disclosure;

FIG. 11 is a flowchart illustrating an example wind noise detection method according to various example embodiments of the present disclosure;

FIG. 12 is a flowchart illustrating an example wind noise cancellation method according to various example embodiments of the present disclosure; and

FIG. 13 is a flowchart illustrating an example method for outputting a wind noise-controlled sound signal according to various example embodiments of the present disclosure.

### DETAILED DESCRIPTION

Hereinafter, various example embodiments of the present disclosure are described in greater detail with reference to the accompanying drawings. While the present disclosure may be embodied in many different forms, specific embodiments of the present disclosure are illustrated in the drawings and are described herein in detail, with the understanding that the present disclosure is to be considered as an example of the principles of the disclosure and is not intended to limit the disclosure to the specific embodiments illustrated. The same reference numbers are used throughout the drawings to refer to the same or like parts.

Expressions may be described herein in detail, with the understanding that the present disclosure is to be considered as an example of the principles of the disclosure. Further, in the present disclosure, a term may be considered as an example of the principles of the disclosure and is not intended to limit the disclosure to the specific embodiments illustrated. The disclosure is directed merely to various examples and does not exclude the presence or addition of at least one other characteristic, numeral, step, operation, element, component, or combination thereof.

An expression of a first and a second in the present disclosure may represent various elements of the present disclosure, but it does not limit the corresponding elements. For example, the expression does not limit an order and/or importance of the corresponding elements. The expression may be used for distinguishing one element from another element. For example, both a first user device and a second user device are user devices and represent different user devices. For example, a first element may be referred to as a second element without deviating from the scope of the present disclosure; and, similarly, a second element may be referred to as a first element.

Terms used in the present disclosure are not to limit the present disclosure but to illustrate example embodiments. When used in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be understood that generally used terms defined in a dictionary have a meaning corresponding to that of a context of related technology and are not considered as an ideal or excessively formal meaning unless explicitly defined.

In this disclosure, an electronic device may be a device that involves a communication function. For example, an electronic device may be a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a portable medical device, a digital camera, or a wearable device (e.g., a Head-Mounted Device (HMD) such as electronic glasses, electronic clothes, an electronic bracelet, an electronic necklace, an electronic accessory, or a smart watch), or the like, but it is not limited thereto.

According to some embodiments, an electronic device may be a smart home appliance that involves a communication function. For example, an electronic device may be a TV, a Digital Video Disk (DVD) player, audio equipment, a refrigerator, an air conditioner, a vacuum cleaner, an oven, a microwave, a washing machine, an air cleaner, a set-top box, a TV box (e.g., Samsung HomeSync′, Apple TV′, Google Tvrn, a game console, an electronic dictionary, an electronic key, a camcorder, or an electronic picture frame, or the like, but is not limited thereto.

According to some embodiments, an electronic device may be a medical device (e.g., magnetic resonance angiography (MRA) scanner), magnetic resonance imaging (MRI) scanner), computed tomography (CT) scanner, ultrasound scanner, etc.), a navigation device, a Global Positioning System (GPS) receiver, an event data recorder (EDR), a flight data recorder (FDR), a car infotainment device, electronic equipment for ship (e.g., a marine navigation system, a gyrocompass), avionics, security equipment, or an industrial or home robot, or the like, but it is not limited thereto.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter), or the like, but it is not limited thereto. An electronic device disclosed herein may be one of the above-mentioned devices or any combination thereof. As well understood by those skilled in the art, the above-mentioned electronic devices are examples only and not to be considered as a limitation of this disclosure.

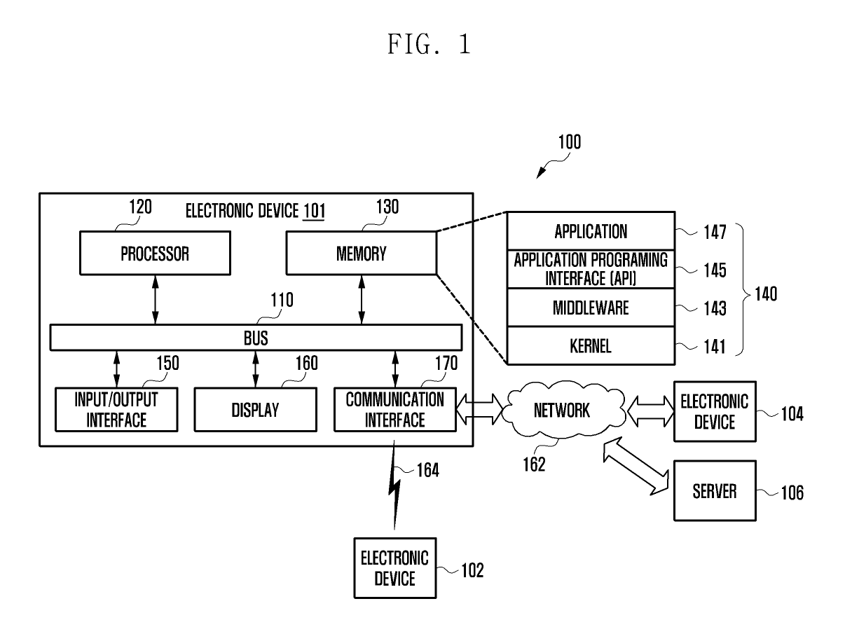

FIG. 1 is a block diagram illustrating an example electronic apparatus in a network environment according to an example embodiment of the present disclosure.

With reference to FIG. 1, the electronic apparatus 101 may include a bus 110, a processor (e.g., including processing circuitry) 120, a memory 130, an input/output interface (e.g., including input/output circuitry) 150, a display 160, and a communication interface (e.g., including communication circuitry) 170.

The bus 110 may be a circuit for interconnecting elements described above and for allowing a communication, e.g. by transferring a control message, between the elements described above.

The processor 120 may include various processing circuitry, such as, for example, and without limitation, a dedicated processor, a CPU, and application processor, or the like, and can receive commands from the above-mentioned other elements, e.g., the memory 130, the input/output interface 150, the display 160, and the communication interface 170, through, for example, the bus 110; can decipher the received commands; and can perform operations and/or data processing according to the deciphered commands.

The memory 130 can store commands received from the processor 120 and/or other elements, e.g. the input/output interface 150, the display 160, and the communication interface 170, and/or commands and/or data generated by the processor 120 and/or other elements. The memory 130 may include software and/or programs 140, such as a kernel 141, middleware 143, an Application Programming Interface (API) 145, and an application 147. Each of the programming modules described above may be configured by software, firmware, hardware, and/or combinations of two or more thereof.

The kernel 141 can control and/or manage system resources, e.g. the bus 110, the processor 120, or the memory 130, used for execution of operations and/or functions implemented in other programming modules, such as the middleware 143, the API 145, and/or the application 147. Further, the kernel 141 can provide an interface through which the middleware 143, the API 145, and/or the application 147 can access and then control and/or manage an individual element of the electronic apparatus 101.

The middleware 143 can perform a relay function which allows the API 145 and/or the application 147 to communicate with and exchange data with the kernel 141. Further, in relation to operation requests received from at least one of an application 147, the middleware 143 can perform load balancing in relation to the operation requests by, for example, giving a priority in using a system resource, e.g. the bus 110, the processor 120, and/or the memory 130, of the electronic apparatus 101 to at least one application from among the at least one of the application 147.

The API 145 is an interface through which the application 147 can control a function provided by the kernel 141 and/or the middleware 143, and may include, for example, at least one interface or function for file control, window control, image processing, and/or character control.

The input/output interface 150 may include various input/output circuitry and can receive, for example, a command and/or data from a user, and transfer the received command and/or data to the processor 120 and/or the memory 130 through the bus 110. The display 160 can display an image, a video, and/or data to a user.

The communication interface 170 may include various communication circuitry and can establish a communication between the electronic apparatus 101 and other electronic devices 102 and 104 and/or a server 106. The communication interface 170 can support short range communication protocols 164, e.g., a Wireless Fidelity (WiFi) protocol, a BlueTooth (BT) protocol, and a Near Field Communication (NFC) protocol; and communication networks, e.g., Internet, Local Area Network (LAN), Wire Area Network (WAN), a telecommunication network, a cellular network, a satellite network, a Plain Old Telephone Service (POTS), or any other similar and/or suitable communication networks, such as network 162, or the like. Each of the electronic devices 102 and 104 may be a same type and/or different types of electronic apparatus.

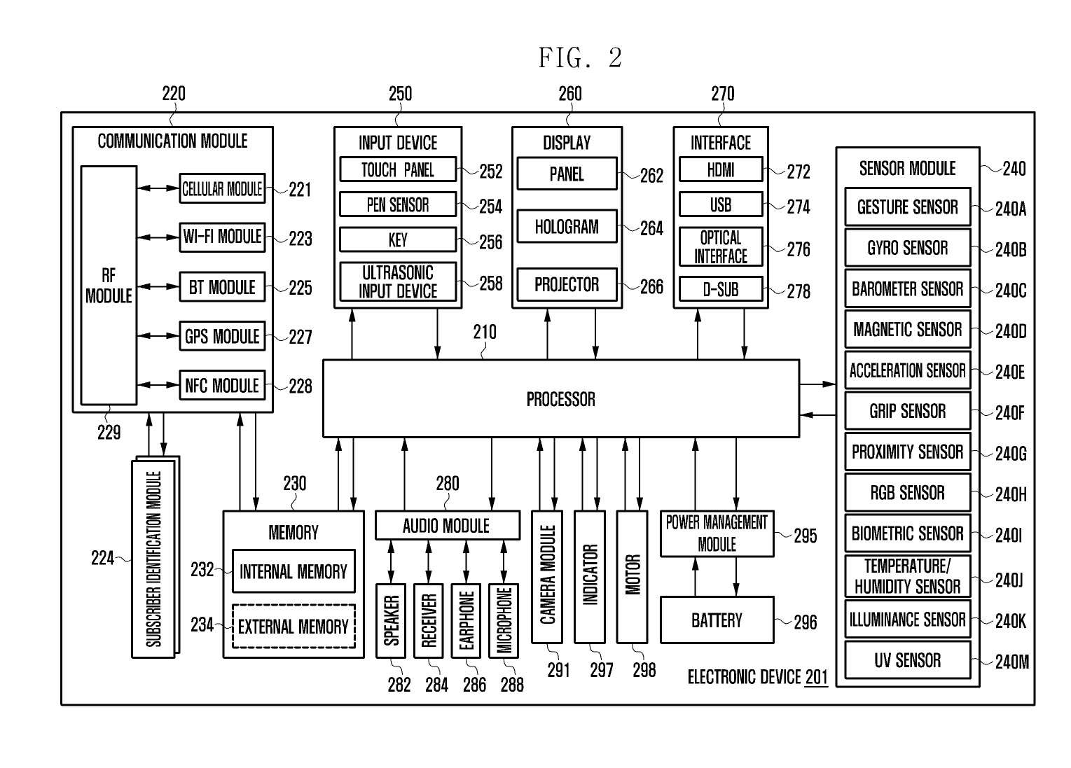

FIG. 2 is a block diagram illustrating an example electronic device according to an example embodiment of the present disclosure. The electronic device 201 may form, for example, the whole or part of the electronic device 101 illustrated in FIG. 1. Referring to FIG. 2, the electronic device 201 may include at least one application processor (AP) (e.g., including processing circuitry) 210, a communication module (e.g., including communication circuitry) 220, a subscriber identification module (SIM) card 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The AP 210 may include various processing circuitry, and drive an operating system or applications, control a plurality of hardware or software components connected thereto, and also perform processing and operation for various data including multimedia data. The AP 210 may be formed of system-on-chip (SoC), for example. According to an embodiment, the AP 210 may further include a graphic processing unit (GPU) (not shown).

The communication module 220 (e.g., the communication interface 170) may include various communication circuitry and perform a data communication with any other electronic device (e.g., the electronic device 104 or the server 106) connected to the electronic device 101 (e.g., the electronic device 201) through the network. According to an embodiment, the communication module 220 may include various communication circuitry, such as, for example, and without limitation, a cellular module 221, a WiFi module 223, a BT module 225, a GPS module 227, an NFC module 228, and a Radio Frequency (RF) module 229.

The cellular module 221 may offer a voice call, a video call, a message service, an internet service, or the like through a communication network (e.g., LTE, LTE-A, CDMA, WCDMA, UMTS, WiBro, or GSM). Additionally, the cellular module 221 may perform identification and authentication of the electronic device in the communication network, using the SIM card 224. According to an embodiment, the cellular module 221 may perform at least part of the functions the AP 210 can provide. For example, the cellular module 221 may perform at least part of a multimedia control function.

According to an embodiment, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, in an embodiment the AP 210 may be formed to have at least part (e.g., the cellular module 221) of the above elements.

According to an embodiment, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227, and the NFC module 228 may include a processor for processing data transmitted or received therethrough. Although FIG. 2 shows the cellular module 221, the WiFi module 223, the BT module 225, the GPS module 227, and the NFC module 228 as different blocks, in an embodiment at least part of them may be contained in a single Integrated Circuit (IC) chip or a single IC package. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227, and the NFC module 228 may be formed as a single SoC.

The RF module 229 may transmit and receive data, e.g., RF signals or any other electric signals. Although not shown, the RF module 229 may include a transceiver, a Power Amp Module (PAM), a frequency filter, a Low Noise Amplifier (LNA), or the like. Also, the RF module 229 may include any component, e.g., a wire or a conductor, for transmission of electromagnetic waves in a free air space. Although FIG. 2 shows that the cellular module 221, the WiFi module 223, the BT module 225, the GPS module 227, and the NFC module 228 share the RF module 229, in an embodiment at least one of them may perform transmission and reception of RF signals through a separate RF module.

The SIM card 224 may be a specific card formed of a SIM and may be inserted into a slot formed at a certain place of the electronic device 201. The SIM card 224 may contain therein an Integrated Circuit Card Identifier (ICCID) or an International Mobile Subscriber Identity (IMSI).

The memory 230 (e.g., the memory 230) may include an internal memory 232 and/or an external memory 234. The internal memory 232 may include, for example, at least one of a volatile memory (e.g., Dynamic RAM (DRAM), Static RAM (SRAM), Synchronous DRAM (SDRAM)) or a nonvolatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory).

According to an embodiment, the internal memory 232 may have the form of a Solid State Drive (SSD). The external memory 234 may include a flash drive, e.g., Compact Flash (CF), Secure Digital (SD), (Micro Secure Digital (Micro-SD), Mini Secure Digital (Mini-SD), eXtreme Digital (xD), memory stick. The external memory 234 may be functionally connected to the electronic device 201 through various interfaces. According to an embodiment, the electronic device 201 may further include a storage device or medium such as a hard drive.

The sensor module 240 may measure a physical quantity or sense an operating status of the electronic device 201, and it may then convert measured or sensed information into electrical signals. The sensor module 240 may include, for example, at least one of a gesture sensor 240A, a gyro sensor 240B, an atmospheric (e.g., barometer) sensor 240C, a magnetic sensor 240D, an acceleration sensor 240E, a grip sensor 240F, a proximity sensor 240G, a color sensor 240H (e.g., Red, Green, Blue (RGB) sensor), a biometric sensor 240I, a temperature-humidity sensor 240J, an illumination (e.g., illuminance/light) sensor 240K, and an ultraviolet (UV) sensor 240M. Additionally or alternatively, the sensor module 240 may include, e.g., an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scan sensor (not shown), or a finger scan sensor (not shown). Also, the sensor module 240 may include a control circuit for controlling one or more sensors equipped therein.

The input device 250 may include various input circuitry, such as, for example, and without limitation, a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 201 through an input tool that generates ultrasonic signals, thus allowing wireless recognition. According to an embodiment, the electronic device 201 may receive a user input from any external device (e.g., a computer or a server) connected thereto through the communication module 220.

The display 260 (e.g., the display 250) may include a panel 262, a hologram 264, or a projector 266. The panel 262 may be, for example, Liquid Crystal Display (LCD), Active Matrix Organic Light Emitting Diode (AM-OLED), or the like. The panel 262 may have a flexible, transparent, or wearable form. The panel 262 may be formed of a single module with the touch panel 252. The hologram 264 may show a stereoscopic image in the air using interference of light. The projector 266 may project an image onto a screen, which may be located at the inside or outside of the electronic device 201. According to an embodiment, the display 260 may further include a control circuit for controlling the panel 262, the hologram 264, and the projector 266.

The interface 270 may include various interface circuitry, such as, for example, and without limitation, a High-Definition Multimedia Interface (HDMI) 272, a Universal Serial Bus (USB) 274, an optical interface 276, or D-subminiature (D-sub) 278. The interface 270 may be contained, for example, in the communication interface 260 shown in FIG. 2. Additionally or alternatively, the interface 270 may include, for example, a Mobile High-definition Link (MHL) interface, a Secure Digital (SD) card/Multi-Media Card (MMC) interface, or an Infrared Data Association (IrDA) interface.

The audio module 280 may perform a conversion between sound and electric signals. The audio module 280 may process sound information inputted or outputted through a speaker 282, a receiver 284, an earphone 286, or a microphone 288.

The camera module 291 is a device capable of obtaining still images and moving images. According to an embodiment, the camera module 291 may include at least one image sensor (e.g., a front sensor or a rear sensor), a lens (not shown), an Image Signal Processor (ISP), not shown), or a flash (e.g., LED or xenon lamp, not shown).

The power management module 295 may manage electric power of the electronic device 201. Although not shown, the power management module 295 may include, for example, a Power Management Integrated Circuit (PMIC), a charger IC, or a battery or fuel gauge.

The PMIC may be formed, for example, of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current, or temperature in a charging process. The battery 296 may store or create electric power therein and supply electric power to the electronic device 201. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electric signal into a mechanical vibration. Although not shown, the electronic device 201 may include a specific processor (e.g., GPU) for supporting a mobile TV. This processor may process media data that comply with the standards of Digital Multimedia Broadcasting (DMB), Digital Video Broadcasting (DVB), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before being integrated.

The term “module” as used herein may refer to one or more hardware (e.g., circuitry), software, firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of a dedicated processor, a CPU, an Application-Specific Integrated Circuit (ASIC) chip, Field-Programmable Gate Arrays (FPGAs), and programmable-logic device, which have been known or are to be developed.

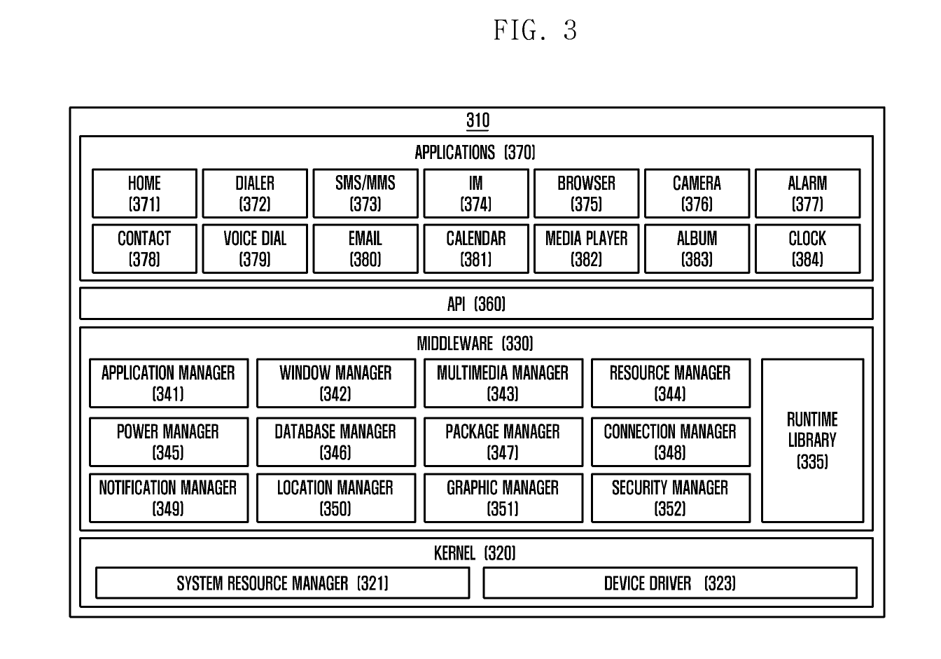

FIG. 3 is a block diagram illustrating an example configuration of a programming module 310 according to an example embodiment of the present disclosure.

The programming module 310 may be included (or stored) in the electronic device 201 (e.g., the memory 230) illustrated in FIG. 2 or may be included (or stored) in the electronic device 101 (e.g., the memory 130) illustrated in FIG. 1. At least a part of the programming module 310 may be implemented in software, firmware, hardware, or a combination of two or more thereof. The programming module 310 may be implemented in hardware, and may include an OS controlling resources related to an electronic device (e.g., the electronic device 101 or 201) and/or various applications (e.g., an application 370) executed in the OS. For example, the OS may be Android, iOS, Windows, Symbian, Tizen, Bada, and the like.

Referring to FIG. 3, the programming module 310 may include a kernel 320, a middleware 330, an API 360, and/or the application 370.

The kernel 320 (e.g., the kernel 141) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an Inter-Process Communication (IPC) driver (not illustrated).

As one of various embodiments of the present disclosure, the display driver may control at least one display driver IC (DDI). The display driver may include the functions for controlling the screen according to the request of the application 370.

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. For example, when at least two displays 260 are connected, the screen may be differently configured or managed in response to the ratio of the screen or the action of the application 370. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 201) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a preloaded application and/or a third-party application. The applications 370 (e.g., the applications 147) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors (e.g., the application processor 210), the one or more processors may perform functions corresponding to the instructions. The non-transitory computer-readable storage medium may be, for example, the memory 220. At least a part of the programming module 310 may be implemented (e.g., executed) by, for example, the one or more processors. At least a part of the programming module 310 may include, for example, a module, a program, a routine, a set of instructions, and/or a process for performing one or more functions.

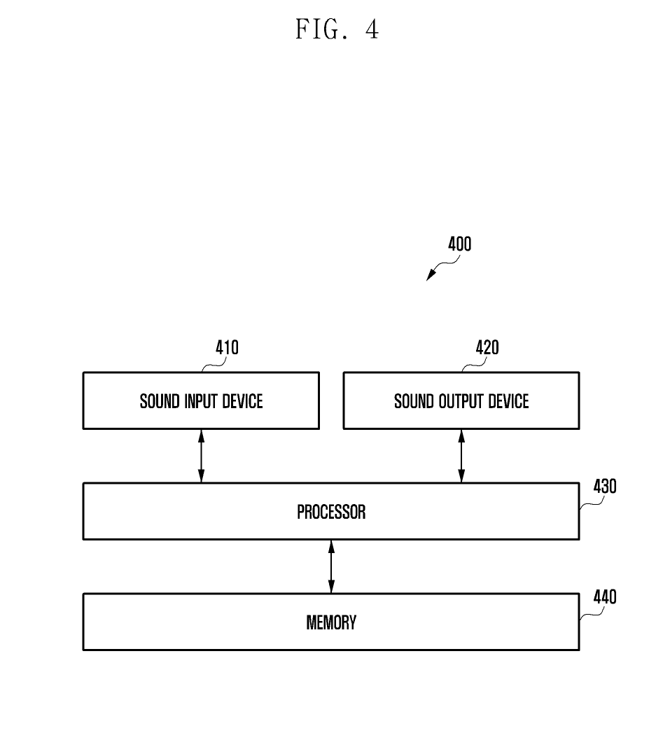

FIG. 4 is a block diagram illustrating an example configuration of an electronic device according to an example embodiment of the present disclosure.

As illustrated in FIG. 4, the electronic device 400 (e.g., electronic device 101 of FIG. 1 or electronic device 201 of FIG. 2) may include a sound input device 410 (e.g., microphone 288 of FIG. 2), a sound output device 420 (e.g., speaker 282, receiver 284, or earphone 268 of FIG. 2) a processor 430 (e.g., processor 120 of FIG. 1 and processor 210 of FIG. 2), and a memory 440 (e.g., memory 130 of FIG. 1 and memory 230 of FIG. 2); at least one of the aforementioned components may be omitted or replaced by an equivalent component in various embodiments. The electronic device 400 may include part of components and/or functions of the electronic device 101 of FIG. 1 and/or the electronic device 201 of FIG. 2.

The sound input device 410 may include various sound input circuitry and detect sounds outside the electronic device 400. According to various embodiments, the sound input device 410 may collect analog sounds and convert the analog sounds to a sound signal (or first signal) as a digital sound signal. For this purpose, the sound input device 410 may include an analog-to-digital (A/D) converter (not shown), which is implemented in hardware and/or software. The sound input device 410 may be implemented in the form of a well-known microphone device and include part of configuration and/or functions of the microphone 288 of FIG. 2.

According to various embodiments of the present disclosure, the electronic device 400 may include one or more sound input devices 410. In the case where the electronic device 400 includes a plurality of sound input devices 410, the sound signals acquired by the sound input devices 410 may be sent to the processor 430 through per-microphone channels or a single channel on which the sound signals are multiplexed.

The sound output device 420 may include various sound output circuitry and output sound data received from the processor 430. The sound output device 420 may include a digital-to-analog (D/A) converter to convert the sound data as a digital signal to an analog signal. The sound output device 420 may be implemented in the form of a well-known device such as a speaker, a receiver, and an earphone. The sound signal output from the sound output device 420 may be a signal from which wind noise has been removed by the processor 430.

The memory 440 may include a volatile memory and non-volatile memory implemented in, but not limited to, a certain manner. The memory 440 may include at least part of the components and/or functions of the memory 130 of FIG. 1 and/or the memory 230 of FIG. 2. The memory 440 may also store at least part of the program module 310 of FIG. 3.

The memory 440 may be electrically connected to the processor 430 and store various instructions executable by the processor 430. The instructions may include control commands for arithmetic and logical operations, data transfer, and input/output that can be recognized by the processor 430.

According to various embodiments of the present disclosure, the processor 430 may include various processing circuitry and be configured to control the components of the electronic device 400 and communication-related operations and data processing and may include at least part of the components of the processor 120 of FIG. 1 and/or the application processor 210 of FIG. 2. The processor 430 may be electrically connected to other internal components of the electronic device 400 such as the sound input device 410, the sound output device 420, and the memory 440.

Although the processor 430 is not limited to the aforementioned operations and functions executable in the electronic device 400, the description is directed to the operation of detecting wind noise from the sound signal collected by the sound input device 410 according to various embodiments of the present disclosure. The processor 430 may execute the operations to be explained hereinafter by loading the instructions stored in the above-described memory 440.

The processor 430 may detect wind noise from the sound signal collected by the sound input device 410 in various manners.

In a comparative example, the processor 430 may remove wind noise from the input sound signal by applying a fixed filter. In light of the characteristics of wind noise, which is in a low frequency spectrum, the processor 430 may cancel the wind noise by removing the low frequency components from the sound signal using a high pass filter. In this comparative example, the input sound signal is filtered with a previous wind noise detection process; thus, the filter operates even when there is no wind noise, resulting in sound quality degradation.

In another comparative example, the electronic device 400 includes a plurality of sound input devices 410, and the processor 430 may detect wind noise by analyzing the sound signal collected by the respective sound input devices 410. In this comparative example, the electronic device 400 has to have at least two microphones, and this requirement may not be appropriate for compact design of the electronic device 400 and may cause wind noise detection failure if at least one microphone is unexpectedly blocked so as not to collect sound signals.

In another comparative example, the processor 430 may detect wind noise by performing multi-band analysis such as cepstrum analysis and mel-frequency cepstrum analysis on the input sound signal. In this comparative example, it is necessary to convert the frequency domain sound signal to a time domain sound signal, resulting in increase of operation amount and limitation in processing the sound signal in real time.

According to various embodiments of the present disclosure, the electronic device 400 is capable of addressing the problems of the above-described comparative examples by performing time domain analysis on the sound signal collected by the sound input device 410.

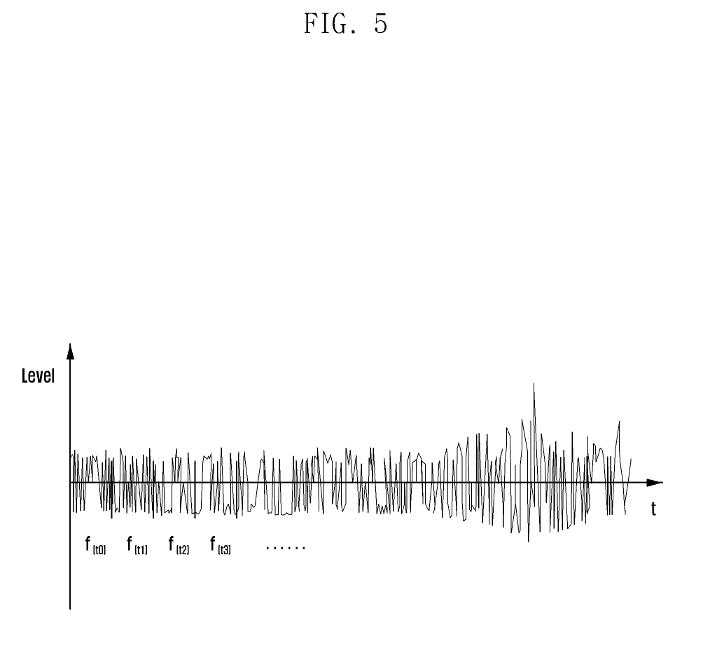

According to various embodiments of the present disclosure, the processor 430 may generate at least one supplementary signal based on the sound signal from the sound input device 410. According to various embodiments of the present disclosure, the at least one supplementary signal is acquired by time-shifting the sound signal by a predetermined time offset, e.g., a delay signal obtained by delaying the sound signal by the predetermined time offset. According to various embodiments of the present disclosure, the sound signal collected by the sound input device 410 may be divided by frame as a time unit, and the at least one supplementary signal may be a sound signal delayed by a predetermined number of frames. More detailed descriptions thereon are made below with reference to FIG. 5.

According to various embodiments of the present disclosure, the processor 430 may detect a third signal corresponding to a wind sound from a first signal input successively using a predetermined detection method based on the first signal and a second signal. That is, the processor 430 may detect at least one frame conveying wind sound among the first to n^{th} frames conveying sound signals input successively. The predetermined detection method may be a procedure of calculating a value indicative of similarity between the sound signal and at least one supplementary signal and inputting the similarity value to a neural network to generate a stationarity value of the sound signal.

According to various embodiments of the present disclosure, the processor 430 may generate at least one parameter based on the input sound signal (or first signal) and at least one supplementary signal (or second signal). According to various embodiments of the present disclosure, the at least one parameter may include the value indicative of similarity between the sound signal and the at least one supplementary signal, and the similarity value may, for example, and without limitation, be one of a chi-square value, a cross correlation value, or a sum of absolute difference between the sound signal and the at least one supplementary signal.

According to various embodiments of the present disclosure, the processor 430 may determine the stationarity of the sound signal based on the at least one parameter. According to various embodiments of the present disclosure, the processor 430 may input the parameter to a neural network with a predetermined coefficient and determine the stationarity of the sound signal based on the output of the neural network.

Here, the coefficient for use in the neural network may be a value determined through prior experiment. For example, it may be possible to input a sound signal and presence/absence of wind noise by frame and analyze stationarity of the sound signal with the wind noise through machine-learning.

According to various embodiments of the present disclosure, the neural network may include a plurality of layers such that a parameter generated based on the sound signal and supplementary signal is input to a first layer and the output of the first layer is input to the next layer (e.g., second layer). Using this layered structure, it may be possible to calculate (determine) a more accurate stationarity value.

According to various embodiments of the present disclosure, if the stationarity is less than a predetermined threshold, the processor 430 may determine that the sound signal includes wind noise. The wind noise is unpredictable and varies irregularly over time; thus, it is possible to determine the presence of wind noise for the case of a low stationarity and the absence of wind noise for the case of a high stationarity.

According to various embodiments of the present disclosure, the processor 430 may perform smoothing on the output of the neural network by means of an infinite impulse response (IIR) filter to acquire a more accurate stationarity and determine presence/absence of wind noise by comparing the filtered value with a predetermined threshold.

According to various embodiments of the present disclosure, if it is determined that wind noise is present, the processor 430 may perform a frequency domain analysis to improve the accuracy of the determination on whether wind noise is present or absent. For example, the processor 430 may convert the sound signal to a frequency domain signal and check the signal level in a low frequency band in which wind noise is typically observed to identify the presence/absence of wind noise in the frequency domain.

According to various embodiments of the present disclosure, if it is determined that wind noise is present in the sound signal (or frame), the processor 430 may remove the wind noise from the sound signal. For example, it may be possible to use a high pass filter to remove the wind noise. According to various embodiments of the present disclosure, the processor 430 may detect a third signal with a wind sound component among a plurality of first signals input successively by frame, remove the wind sound component from the third signal using the high pass filter, and output the wind sound component-removed third signal and the first signals having no wind sound component. That is, the electronic device according to various embodiments of the present disclosure is capable of performing noise cancellation on only the sound signal with wind noise detected through time-domain analysis by means of a filter, thereby protecting against unnecessary sound quality degradation in the whole sound signal.

Although not shown in FIG. 4, the electronic device 400 may further include, but is not limited to, a display (e.g., display 260 of FIG. 2), a communication module (e.g., communication module 220 of FIG. 2), and a sensor module (e.g., sensor module 240 of FIG. 2).

FIG. 5 is a graph illustrating an example waveform of a sound signal for examining a sound noise cancellation method according to an example embodiment of the present disclosure.

FIG. 5 shows change of signal level of an input sound signal as times passes, t0 indicates current time, and a value on the x axis which is greater than t0 indicates a time earlier than t0 in reference to the y axis.

According to various embodiments of the present disclosure, a sound input device (e.g., sound input device 410 of FIG. 4) may collect analog sound, convert the analog sound to a sound signal as a digital signal, and send the sound signal to a processor (e.g., processor 430 of FIG. 4).

The processor may divide the sound signal by frame as a predetermined time unit. For example, the processor may determine 256 or 512 samples of the sound signal sampled at 48 kHz or 10 msec in the time unit as a frame. Although a specific value is used in the description, the frame size is not limited thereto.

The processor may generate at least one supplementary signal based on a sound signal in units of frame. Here, the supplementary signal may be a previous frame time-shifted from the current frame.

For example, the supplementary signals generated based on the frame f(t₀) input at time t₀ (or first time point) may include frame f(t₁) input at a previous time (or second time point), frame f(t₂) input at a previous time (or third time point), and frame f(t₃) input at a previous time (or fourth time point). Likewise, the supplementary signals generated for detecting wind noise from the sound signal f(t₁) may include f(t₂), f(t₃), and f(t₄). Since the processor receives the sound signal successively from the sound input device, a sound signal input at a certain time point (or in a time period) may be a supplementary signal of a sound signal being input at the next time point.

Although the description is made under the assumption that the processor generates supplementary signals of three frames based on one frame in various embodiments of the present disclosure, the number of frames of supplementary signals is not limited thereto. The processor may detect presence/absence of wind noise in every frame and perform filtering for canceling wind noise only on the frame having wind noise.

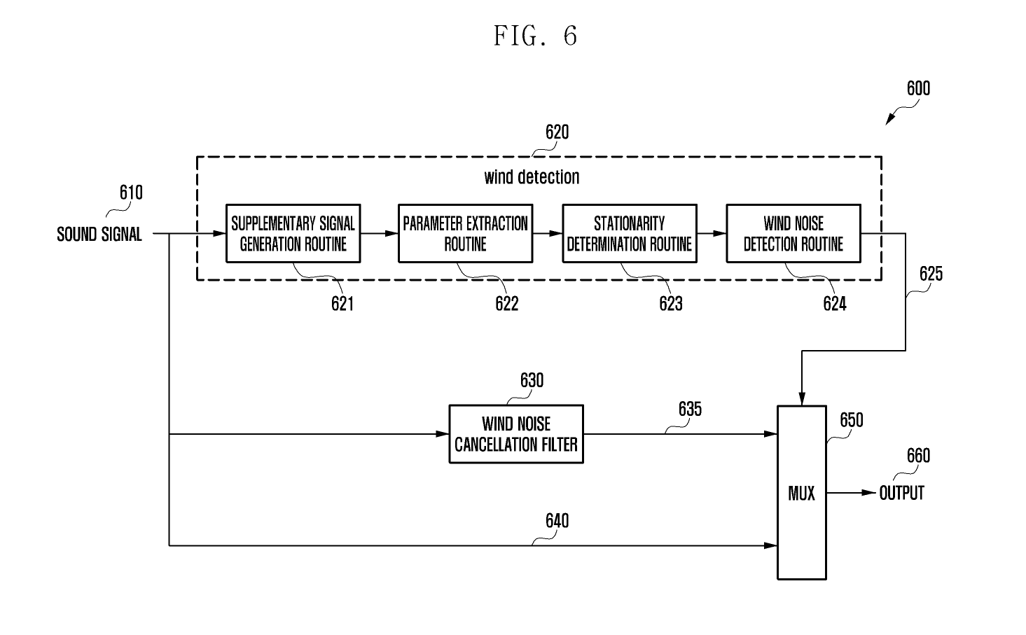

FIG. 6 is a block diagram illustrating an example operation of a processor according to an example embodiment of the present disclosure.

The processor 600 (e.g., processor 430 of FIG. 4) executes a wind noise detection routine 620 for detecting wind noise in an input sound signal, and the wind noise detection routine 620 may include a supplementary signal generation routine 621, a parameter extraction routine 622, a stationarity determination routine 623, and a wind noise detection routine 624. Each routine may refer, for example, to a program for executing a specific task and, according to an embodiment of the present disclosure, the at least one routine may be executed by a separate hardware component embedded in the processor 600.

The processor 600 may execute the wind noise detection routine 620 on the sound signal 610 collected by the sound input device (e.g., sound input device 410 of FIG. 4). The sound signal 610 may run through a path 635 on which a wind noise cancellation filter 630 is placed and a bypass 640. The signals output through the respective paths 625, 635, and 640 are input to a multiplexer (MUX) 650, which may include a buffer (not shown) to achieve synchronization of the signals input through the respective paths 625, 635, and 640.

According to various embodiments of the present disclosure, the processor 600 may execute the supplementary signal generation routine 621 to generate at least one supplementary signal from the input sound signal 610. The sound signal may be input by frame in the time domain, and the supplementary signal may correspond to at least one frame preceding the sound signal frame as described with reference to FIG. 5. According to another embodiment of the present disclosure, the size of a supplementary signal (e.g., time unit) may be different from the size of a frame.

The processor 600 may execute the parameter extraction routine 622 to generate at least one parameter based on the sound signal and at least one supplementary signal. Here, the at least one parameter may include, for example, similarity between signals and, in the case of using multiple supplementary signals, the processor 600 may calculate the similarity between the sound signal and each of the supplementary signals.

According to an embodiment of the present disclosure, the parameter may be a chi-square value calculated as follows:

$${χ}^{2} = {( {o}_{12} - {o}_{22} )}^{2} ( \frac{1}{( {o}_{12} + {o}_{22} )} + \frac{1}{( N - {o}_{12} - {o}_{22} )} )$$

where o₁₂ and o₂₂ denote numbers of negative samples of the sound signal (e.g., f(t₀)) and supplementary signal (e.g., f(t₁)), and N denotes the length of a frame. The processor 600 may calculate chi-square values by inputting the sound signal and each of the supplementary signals.

According to another embodiment of the present disclosure, the parameter may be a cross correlation value calculated as follows:

$$r = {max}_{k = - K … K} ( \frac{{\sum }_{i} {s}_{0} ( i ) {s}_{1} ( i + k )}{{σ}_{0} {σ}_{1}} )$$

where s₀(n) and s₁(n) denote samples of the sound signals (e.g., f(t₀)) and supplementary signal (e.g., f(t₁)), and σ₀ and σ₁ denote root mean square (RMS) values of f(t₀) and f(t₁). K denotes the length of a cross correlation function wing and is set to a value up to 8 in 8k sampling.

According to another embodiment of the present disclosure, the parameter may be a sum of absolute difference calculated as follows:

$$d = {min}_{k = - K … K} ( {\sum }_{i} \frac{abs ( {s}_{0} ( i ) - {s}_{1} ( i + k ) )}{\sqrt{{σ}_{0} {σ}_{1}}} )$$

where s₀(n) and s₁(n) denote samples of the sound signals (e.g., f(t₀)) and supplementary signal (e.g., f(t₁)), and σ₀ and σ₁ denote RMS values of f(t₀) and f(t₁). K denotes the length of a SAD function wing and is set to a value up to 8 in 8k sampling.

At least one parameter value generated in the parameter extraction routine 622 may be input to the stationarity determination routine 623.

The processor 600 may determine the stationarity of the sound signal based on the at least one parameter by means of the stationary determination routine 623. According to various embodiments, the processor 600 may input the parameter to a neural network with a predetermined coefficient to determine the stationarity of the sound signal based on the output of the neural network.

According to an embodiment of the present disclosure, the processor 600 may calculate the stationarity for detecting wind noise using a distributed delay neural network. The distributed delay neural network may have input values such as parameter p₁ extracted from the sound signal (e.g., f(t₀)) and the first supplementary signal (e.g., f(t₁)), parameter p₂ extracted from the sound signal (e.g., f(t₀)) and the second supplementary signal (e.g., f(t₂)), and parameter p₃ extracted from the sound signal (e.g., f(t₀)) and the third supplementary signal (e.g., f(t₃)). The distributed delay neural network may extract the stationarity through a non-linear analysis.

The coefficients for use in the neural network may be the values determined through prior experiment. For example, it may be possible to input diverse characteristics of a sound signal in unit of a frame and presence/absence of wind noise to the neural network and analyze the stationarity characteristic of the sound signal with wind noise through machine-learning.

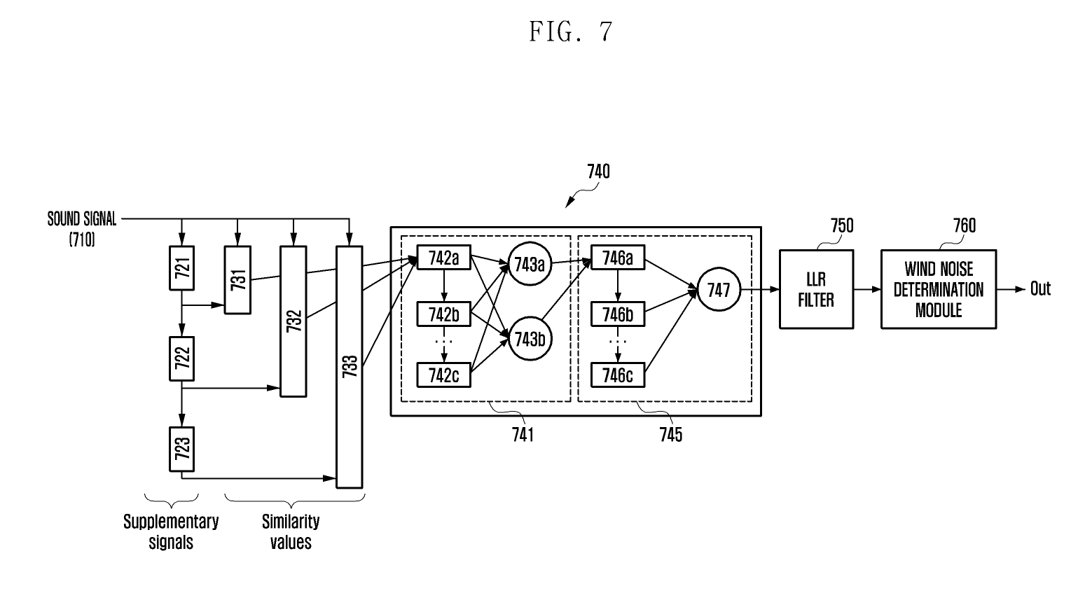

According to an embodiment of the present disclosure, the neural network may include a plurality of layers. In this case, the parameters p₁, p₂, and p₃ may be input to the first layer, and the outputs of the first layer are input to the second layer. The layered structure of the neural network is described in detail below with reference to FIG. 7.

The processor 600 may perform smoothing on the stationarity value output from the stationarity determination routine 623 by means of an IIR filter. According to an embodiment of the present disclosure, the processor 600 may have no IIR filter and, in this case, the stationarity value output from the stationarity determination routine 623 may be directly input to the wind noise detection routine 624.

The processor 600 may compare the smoothed stationarity value (or the stationarity value output from the stationarity determination routine 623) with a threshold by means of the wind noise detection routine 624 to determine whether the sound signal (or frame) has wind noise. The wind noise is unpredictable and varies irregularly over time time; thus it is possible to determine the presence of wind noise for the case of a low stationarity and the absence of wind noise for the case of a high stationarity.

According to an embodiment of the present disclosure, it may be possible to consider hysteresis in comparing the stationarity value with the threshold in the wind noise determination. For example, there may be some difference between a stationarity curve and stationarity of the real sound signal because the supplementary signal as previous time information is taken into account in calculating the stationarity; thus, the processor 600 can detect wind noise more accurately in a frame by reflecting the determination result at the previous frame along with hysteresis.

The output signal 625 of the wind noise detection routine 620 is input to the multiplexer 650, which multiplexes the sound signal that has passed the wind noise cancellation filter 630 on the path 635 and the bypassed sound signal. The multiplexer 650 may output the wind noise-cancelled sound signal 635 for the case where it is determined that the wind noise is present based on the result of the wind noise detection routine 620 or the bypassed sound signal 640 for the case where it is determined that the wind noise is absent based on the result of the wind noise detection routine 620.

FIG. 7 is a diagram illustrating an example process of detecting wind noise in a sound signal according to various example embodiments of the present disclosure.

In reference to FIG. 7, a processor (e.g., processor 410 of FIG. 4) may generate supplementary signals 721, 722, and 723 by time-shifting an input sound signal 710. Although FIG. 7 depicts an example case of generating supplementary signals 721, 722, and 723 conveyed in the three frames preceding the sound signal frame conveying the sound signal 710, how to generate the supplementary signals is not limited thereto.

The sound signal 710 and the supplementary signals 721, 722, and 723 may be generated in real time. For example, it may be possible to generate supplementary signals f(t₁), f(t₂), and f(t₃) of the sound signal f(t₀) at time point t₀ and supplementary signals f(t₂), f(t₃), and f(t₄) of the sound signal f(t₁) at time point t₁. That is, the sound signal f(t₁) at the time point t₁ may be used as a supplementary signal at the next time point t₀.

The processor may calculate the similarity between the sound signal 710 and each of the supplementary signals 721, 722, and 723 (e.g., chi-square value and cross correlation value, and sum of absolute difference). The calculated similarity values 731, 732, and 733 may be input to a neural network 740.

FIG. 7 depicts a neural network 740 configured in a layered structure with two layers 741 and 745. That is, the similarity values 731, 732, and 733 are input to the first layer 741 so as to be summed, and the values sequentially output from the first layer 741 are input to the second layer 745. According to an embodiment of the present disclosure, the first layer 741 may include a chain of delays 742a, 742b, and 742c for 20 frames, and the second layer 745 may include a chain of delays 746a, 746b, and 746c for 4 frames. As a consequence, a total of 24 frames can be used for signal history monitoring.

As shown in FIG. 7, the similarity values 731, 732, and 733 between the sound signal 710 and the respective supplementary signals 731, 732, and 733 at the time point t₀ may be input to the first delay 742a to be summed; the respective similarity values 731, 732, and 733 may be multiplied by predetermined coefficient values. Likewise, the similarity values at the time point t₁ may be input to the second delay 742b, and the similarity values at the time point t₂ may be input to the third delay 742c.

The output values of a total of 20 delays including the delays 742a, 742b, and 742c may be input to a first neuron 743a and, in this way, the first layer may generate a total of 15 neuron values.

The values output from the 15 neurons of the first layer 741 may be input to the first delay 746a of the second layer 745. The second layer 745 may have 4 frame delay chains including the chain of delays 746a, 746b, and 746c, and the four delay values are summed and then input to a neuron 747. The value of the neuron 747 of the second layer 745 may be determined as a stationarity value and thus input to an IIR filter 750.

Although specific numbers of delays, neurons, and layers are depicted in the drawing, the present disclosure is not limited thereby.

In the neural network 740, the input parameters may be multiplied by respective coefficients before being summed, and the coefficients may be the values determined through prior experiment. The neural network 740 may use the coefficients trained with various prerecorded wind noises and may improve accuracy by updating the coefficients in the course of real operation. In this way, it may be possible to discriminate wind noise from other noises such as branch cracking, bursts, and fire noise.

It is not mandatory to perform the prior experiment for determining the coefficients using the electronic device, which may store the coefficient values in its memory (e.g., memory 440 of FIG. 4) and update the coefficient values by receiving new coefficient values by means of a communication module (e.g., communication module 220 of FIG. 2).

The processor may perform smoothing on the stationarity value output from the neural network 740 by means of the IIR filter 750.

The processor may compare the smoothed stationarity value with a threshold value to determine whether wind noise is present in the corresponding sound signal (or frame) by means of a wind noise determination module 760.

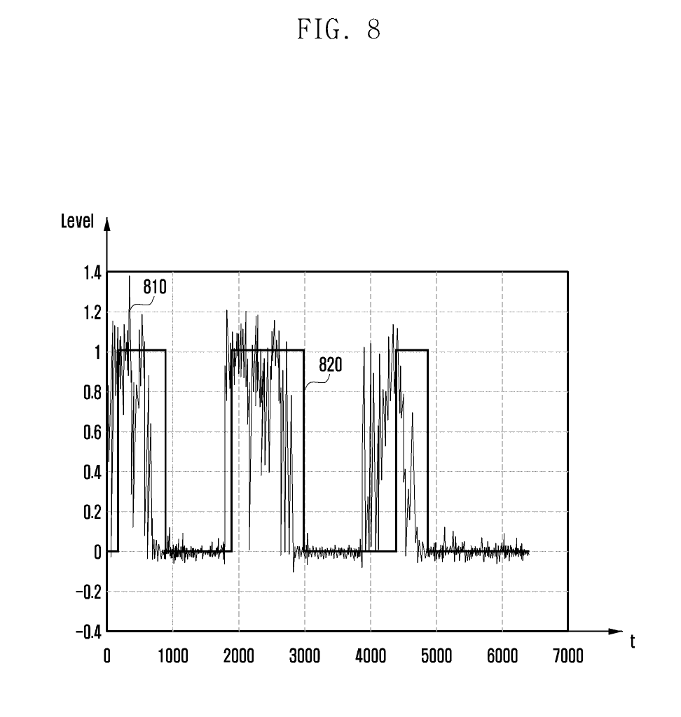

FIG. 8 is a graph illustrating an example waveform of a sound signal including wind noise for explaining wind noise detection method according to various example embodiments of the present disclosure.

In FIG. 8, reference number 810 denotes a waveform of the neural network, and reference number 820 denotes a digital waveform indicative of presence of wind noise with level 1 and absence of wind noise with level 0.

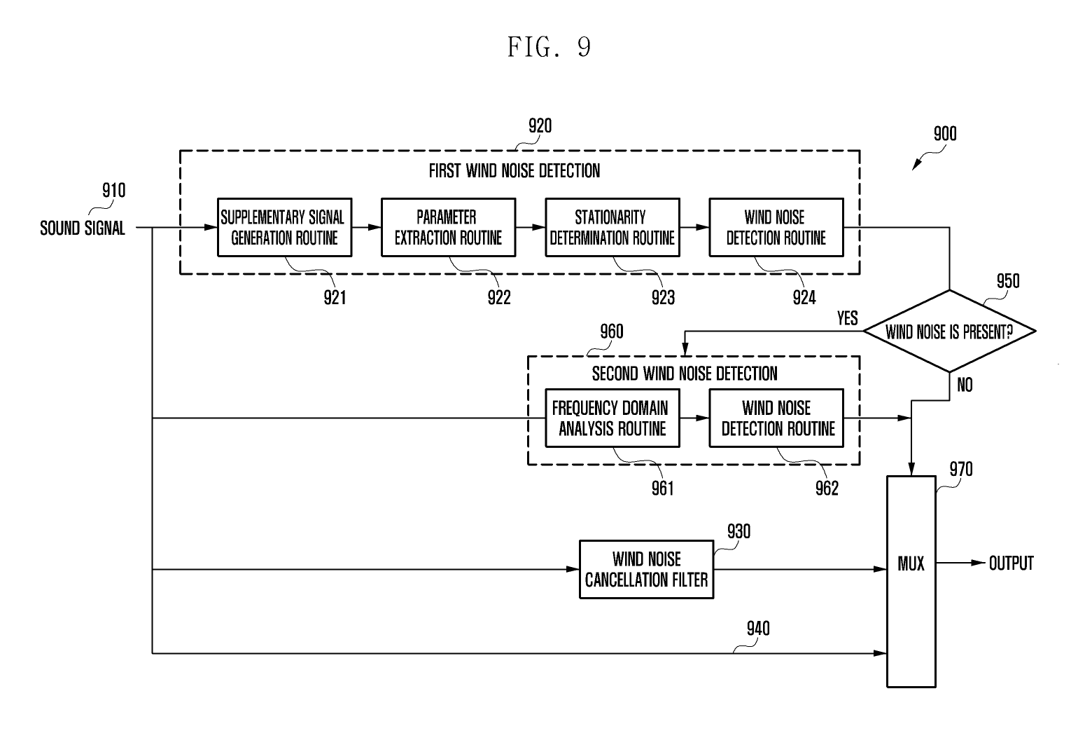

FIG. 9 is a diagram illustrating an example single channel wind noise detection mechanism according to various example embodiments of the present disclosure.

According to an embodiment of the present disclosure, an electronic device (e.g., electronic device 400 of FIG. 4) includes a sound input device (e.g., sound input device 410 of FIG. 4), which may collect sound data and input the collected sound data to a processor (e.g., processor 430 of FIG. 4) through one channel. FIG. 9 depicts the operation of a processor 900 for detecting wind noise in the sound signal input from the sound input device through one channel.

The processor 900 may control such that the sound signal 910 is input through at least one of a first wind noise detection routine 920, a second wind noise detection routine 960, a wind noise cancellation filter 930, and a bypass 940. The first wind noise detection routine 920 is executed to detect presence/absence through a time domain process and may be identical with or similar to the wind noise detection routine 620 of FIG. 6. Therefore, a description thereof will not be repeated here.

The second wind noise detection routine 960 is a frequency domain analysis process including a frequency domain analysis routine 961 for converting the time domain sound signal 910 to a frequency domain sound signal and analyzing the frequency domain components of the sound signal and a wind noise detection routine 962 for checking a signal level in the low frequency band, wind noise being in a low frequency spectrum, to determine presence/absence of wind noise. The low frequency spectrum wind noise detection operation of the second wind noise detection routine 960 is well-known in the art; thus, a detailed description thereof is omitted herein.

According to an embodiment of the present disclosure, the information on the presence/absence of wind noise as the execution result of the first wind noise detection routine 920 may be input to a multiplexer 970. Also, the information on the presence/absence of wind noise as the execution result of the second wind noise detection routine 960 may be input to the multiplexer 970. The multiplexer 970 may remove, if it is determined as the execution result of the first and second wind noise detection routines 920 and 960 that wind noise is present, wind noise from the sound signal by means of a wind noise cancellation filter 930 and then output the wind noise-cancelled sound signal; if it is determined as the execution result of the first and second wind noise detection routines 920 and 930 that wind noise is absent, the multiplexer 970 may output bypassed sound signal 940.

According to an embodiment of the present disclosure, the first and second noise detection routines 920 and 960 may be executed on the same path. For example, if it is determined as the execution result of the first wind noise detection routine 920 that wind noise is present in the sound signal 910, the sound signal is input to the second wind noise detection routine 960 and then the execution result of the second wind noise detection routine 960 is input to the multiplexer 970. Otherwise, if it is determined as the result of the first noise detection routine 920 that wind noise is absent, the execution result is directly input to the multiplexer 970 without execution of the second wind noise detection routine 960.

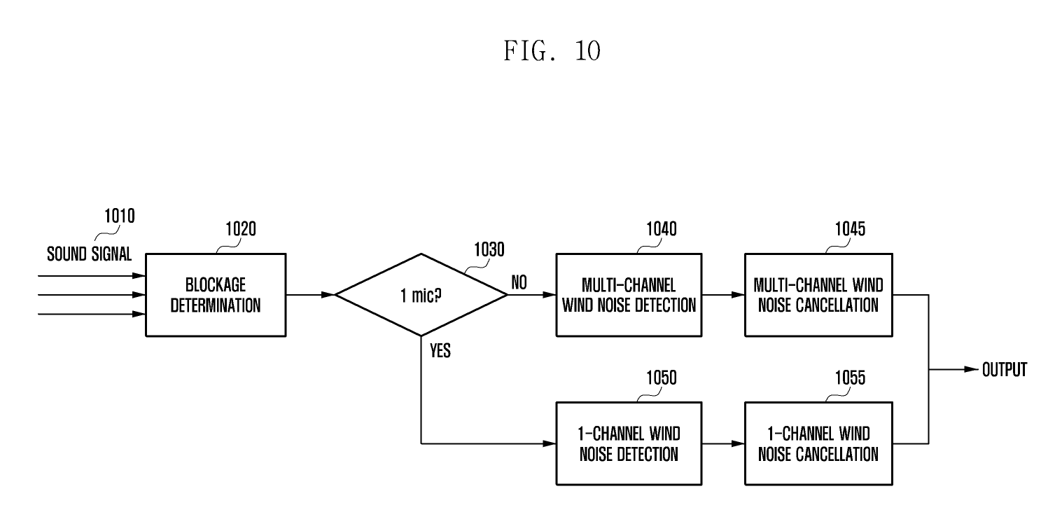

FIG. 10 is a diagram illustrating an example multi-channel wind noise detection mechanism of an electronic device according to various example embodiments of the present disclosure.

According to an embodiment of the present disclosure, the electronic device (e.g., electronic device 400 of FIG. 4) may include a plurality of sound input devices (e.g., sound input device 410 of FIG. 4), which collect a sound signal 1010 and input the sound signal to a processor (e.g., processor 430 of FIG. 4) through separate channels. FIG. 10 illustrates the operation of the processor for detecting wind noise in the sound signal input through multiple channels.

The processor may detect, at step 1020, when each of the sound input devices of the electronic device is blocked. According to an embodiment of the present disclosure, the processor may determine whether each sound input device is blocked by an external object based on the size and characteristic of the sound signal 1010 input through each channel.

The processor may determine at step 1030 whether the number of unblocked sound input devices is equal to or greater than 2 and thus that the sound signal is input through two or more channels and, if so, the processor may detect wind noise using the sound signal input through the multiple channel at step 1040 and remove the wind noise at step 1045.

If it is determined at step 1030 that the number of unblocked sound input devices is 1, the processor may perform a single-channel wind noise detection at step 1050. Here, at step 1050, the single channel wind noise detection operation may include the wind noise detection routine 620 of FIG. 6 (or first wind noise detection routine 920 of FIG. 9). If wind noise is detected, the processor may remove the wind noise from the sound signal at step 1055.

According to various example embodiments of the present disclosure, the electronic device may include an input device, and output device, and a processor; the processor may be configured to acquire a first signal corresponding to the external sound around the electronic device by means of the input device, generate a second signal by delaying the first signal for a predetermined amount of time, detect a third signal corresponding to wind noise in the first signal using a predetermined detection method based on the first and second signals, and output a fourth signal obtained by controlling the third signal in the first signal by means of the output device.

According to various example embodiments of the present disclosure, the first signal may include a first frame corresponding to a first time point, and the processor may be configured to generate the second signal including a second frame corresponding to the second time point as at least part of the operation of generating the second signal, the second time point being earlier than the first time point.

According to various example embodiments of the present disclosure, the processor may be configured to determine similarity between the first and second signals; determine a stationarity value of the first signal at least based on part of the similarity; detect, when the stationarity value fulfills a predetermined condition, the presence of the third signal in the first signal, as at least part of the wind noise detection method.

According to various example embodiments of the present disclosure, the processor may be configured to use at least one of the chi-square value, cross correlation value, and sum of absolute difference of the first and second signals as at least part of determining a similarity value.

According to various example embodiments of the present disclosure, the processor may be configured to determine similarity between the first and second signals, input the similarity to a neural network model with a predetermined coefficient, determine stationarity of the first signal at least based on the output of the neural network model, and detect the third signal at least based on part of the stationarity, as at least part of the wind noise detection method.

According to various example embodiments of the present disclosure, the neural network may be configured to include multiple layers, and the processor may be configured to input the similarity to the first layer of the multiple layers and input the output value of the first layer to a second layer, the first and second layers being different from each other.

According to various example embodiments of the present disclosure, the processor may be configured to determine, when the stationarity value is less than a predetermined threshold, that a predetermined condition is fulfilled.

According to various example embodiments, the input device may be configured to include a first input device and a second input device, and the processor may be configured to receive the first signal using an unblocked one of the first and second input devices.

According to various example embodiments of the present disclosure, the processor may be configured to generate, when the third signal is detected, the fourth signal by controlling the third signal in the first signal.

According to various example embodiments of the present disclosure, the processor may be configured to detect the third signal by analyzing the first and second signal in the time domain as at least part of the predetermined detection method.

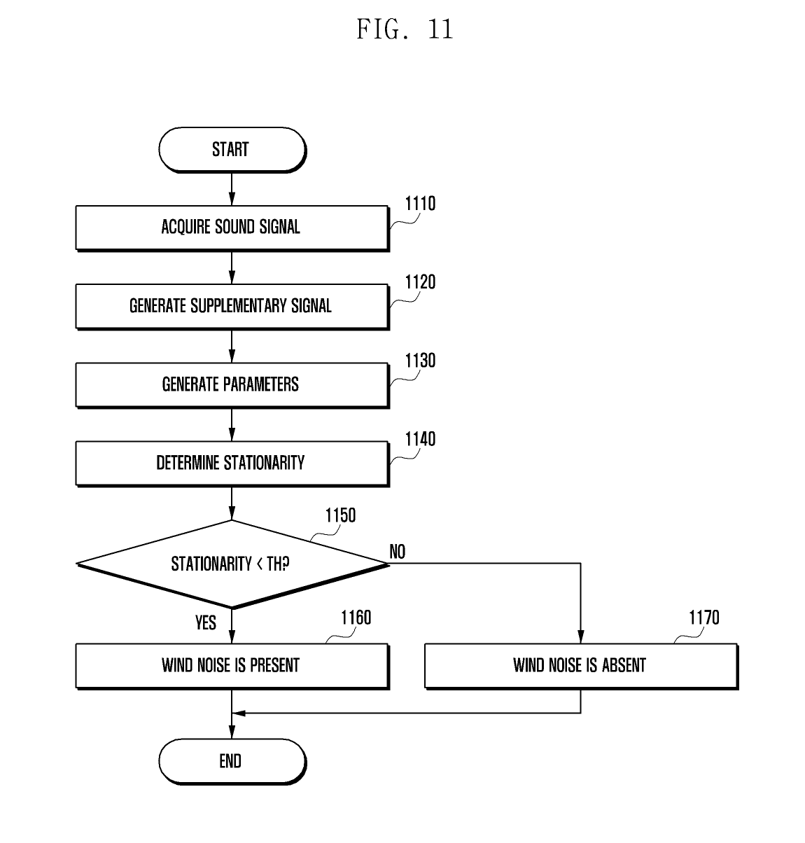

FIG. 11 is a flowchart illustrating an example wind noise detection method according to various example embodiments of the present disclosure.

The wind noise detection method of FIG. 11 may be performed by an electronic device (e.g., electronic device 400 of FIG. 4) described with reference to FIGS. 1 to 10, and the technical features described above are thus not repeated here.

The electronic device may acquire a sound signal by means of a sound input device (e.g., sound input device 410 of FIG. 4) at 1110. The sound input device may collect analog sound, convert the analog sound to a digital sound signal, and transfer the sound signal to a processor (e.g., processor 430 of FIG. 4).

The processor may generate at least one supplementary signal from the sound signal at 1120. Here, the sound signal may be a frame, and the supplementary signal may be at least one frame preceding the sound signal frame as described above with reference to FIG. 5.

The processor may generate at least one parameter at 1130 based on the sound signal and the at least one supplementary signal. Here, the at least one parameter may include values indicative of similarities between signals and, when using multiple supplementary signals, the processor may calculate similarity between the sound signal and respective supplementary signals. According to various embodiments, the similarity values may include at least one of chi-square value, cross correlation value, and sum of absolute difference of the sound signal and the at least one supplementary signal.

At 1140, the processor may determine the stationarity of the sound signal based on the at least one parameter generated at step 1130. According to various embodiments of the present disclosure, the processor may input the parameter to a neural network (e.g., neural network 740 of FIG. 7) with a predetermined coefficient to determine the stationarity.

The processor may calculate the stationarity for detecting wind noise using a distributed delay neural network as described above with reference to FIGS. 6 and 7.

The processor may compare the stationarity of the sound signal with a threshold at 1150. If it is determined that the stationarity is less than the threshold, at 1160 the processor may determine the presence of wind noise; if it is determined that the stationarity is equal to or greater than the threshold, at 1170 the procedure may determine absence of wind noise.

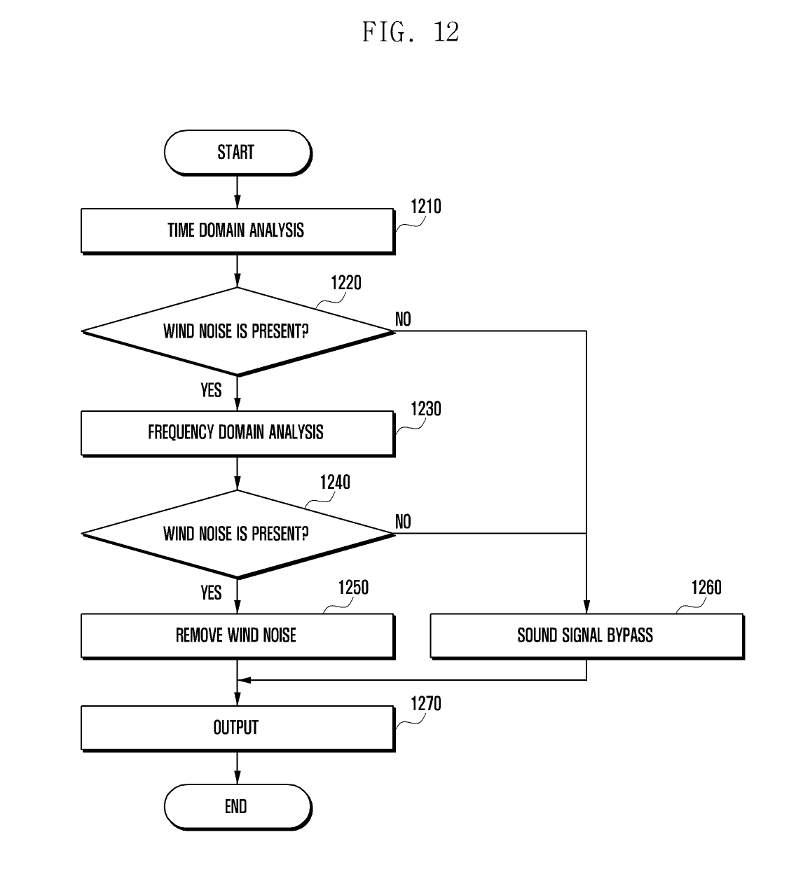

FIG. 12 is a flowchart illustrating an example wind noise cancellation method according to various example embodiments of the present disclosure.

The wind noise cancellation method of FIG. 12 may be performed by an electronic device described with reference to FIGS. 1 to 11, and the technical features described above are thus not repeated here.

A processor (e.g., processor 430 of FIG. 4) of the electronic device may perform time domain analysis on the input sound signal to detect presence of wind noise at 1210.

The processor may determine at 1220 whether wind noise is present in the sound signal and, if it is determined that wind noise is present, perform frequency domain analysis on the sound signal at 1230.

If it is determined at 1220 that wind noise is absent, the sound signal may, at 1260, bypass the frequency domain analysis process of steps 1230 and 1240.

If it is determined at 1240 that wind noise is present, the processor may remove wind noise from the sound signal at 1250.

Then, the processor may output the wind noise-removed sound signal or the bypassed sound signal at 1270.

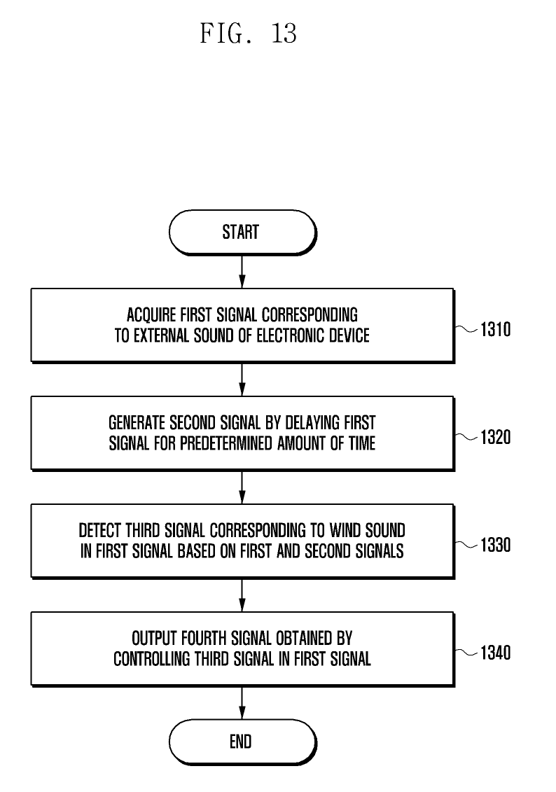

FIG. 13 is a flowchart illustrating an example method for outputting a wind noise-controlled sound signal according to various example embodiments of the present disclosure.

The wind noise-controlled sound signal output method of FIG. 13 may be performed by an electronic device described with reference to FIGS. 1 to 11, and the technical features described above are thus not repeated here.

The processor (e.g., processor 430 of FIG. 4) may acquire a first signal (or sound signal) corresponding to external sound of the electronic device by means of an input device (e.g., sound input device 410 of FIG. 4) at 1310.

The processor may generate a second signal (or supplementary signal) by delaying the first signal for a predetermined amount of time at 1320. According to various embodiments, the first signal may be a frame as a predetermined time unit at a first time point, and the supplementary signal may be at least one frame corresponding to at least one time point preceding the first time point.

The processor may detect at 1330 a third signal corresponding to wind sound in the first signal according to a predetermined detection method based on the first and second signals. According to various embodiments of the present disclosure, the processor may determine a similarity value (e.g., chi-square value, cross correlation value, and sum of absolute difference) between the first and second signals, input the similarity value to a neural network model with a predetermined coefficient to determine a first stationarity value based on the output of the neural network model, and detect the third signal including the wind noise based on the stationarity value.

The processor may output at 1340 a fourth signal obtained by controlling the third signal in the first signal by means of an output device (e.g., sound output device 420 of FIG. 4).

According to various example embodiments of the present disclosure, a wind sound-controlled signal output method of an electronic device may include acquiring a first signal corresponding to external sound of the electronic device, generating a second signal by delaying the first signal for a predetermined amount of time, detecting a third signal corresponding to the wind sound in the first signal using a predetermined detection method based on the first and second signals, and outputting a fourth signal obtained by controlling the third signal in the first signal.

According to various example embodiments of the present disclosure, the first signal may include a first frame corresponding to a first time point, and generating the second signal may include generating the second signal including a second frame corresponding to a second time point preceding the first time point.

According to various example embodiments of the present disclosure, detecting the third signal may include determining similarity between the first and second signals; determining stationarity of the first signal based on at least part of the similarity; and detecting, when the stationarity fulfills a predetermined condition, presence of the third signal in the first signal.

According to various example embodiments of the present disclosure, the similarity may be determined based on at least one of a chi-square value, cross correlation value, and sum of absolute difference of the first and second signals.

According to various example embodiments of the present disclosure, detecting the third signal may include determining similarity between the first and second signals, inputting the similarity to a neural network with a predetermined coefficient, determining stationarity of the first signal based on output of the neural network, and detecting the third signal based on at least part of the stationarity.

According to various example embodiments of the present disclosure, the neural network may include multiple layers, and determining the stationarity of the first signal may include inputting the similarity to a first layer of the multiple layers and inputting an output of the first layer to a second layer, the first and second layers being different from each other.

According to various example embodiments of the present disclosure, detecting the presence of the third signal in the first signal may include determining, when the stationarity is less than a predetermined threshold, that the stationarity fulfils the predetermined condition.

According to various example embodiments of the present disclosure, the electronic device may further include a first input device and a second input device, and acquiring the first signal comprises receiving the first signal input through one of the first and second input devices.

According to various example embodiments of the present disclosure, outputting the fourth signal may include generating, when the third signal is detected, the fourth signal by controlling the third signal in the first signal.

According to various example embodiments of the present disclosure, a computer readable storage medium may store a program for executing operations of acquiring a first signal corresponding to external sound of an electronic device, generating a second signal by delaying the first signal for a predetermined time amount, detecting a third signal corresponding to the wind sound in the first signal using a predetermined detection method based on the first and second signals, and outputting a fourth signal obtained by controlling the third signal in the first signal.

Here, the computer-readable storage media may include, for example, magnetic storage media (e.g., read-only memory (ROM), random-access memory (RAM), a floppy disk, and a hard disk) and optical storage media (e.g., compact disc (CD) ROM and digital video disc (DVD) ROM). The computer-readable storage media may be distributed over computer systems connected to a network in order for the computer-readable codes to be stored and executed in a distributed manner. The computer-readable codes may be stored in the storage media and executed by a processor.

As described above, the wind noise cancellation method and device of the present disclosure is advantageous in terms of detecting wind noise without extra hardware devices and with a low computation amount when the device is equipped with at least one sound input apparatus or in a situation capable of using at least one sound input apparatus.

While the present disclosure has been described with reference to various example embodiments, it will be understood that the various example embodiments are intended to be illustrative, not limiting. One of ordinary skill in the art will understand that various modifications, variations and/or alternatives fall within the spirit and scope of the disclosure as recited in the appended claims.

What is claimed is:

1. An electronic device, comprising:
an input device comprising input circuitry;
an output device comprising output circuitry; and
a processor configured to:
control the input device to acquire a first signal corresponding to external sound of the electronic device,
generate a second signal by delaying the first signal for a predetermined amount of time, to detect a third signal corresponding to a wind sound in the first signal based on the first and second signals, and
control the output device to output a fourth signal obtained by controlling the third signal in the first signal.

2. The electronic device of claim 1, wherein the first signal comprises a first frame corresponding to a first time point, and the processor is configured to generate the second signal including a second frame corresponding to a second time point preceding the first time point as at least part of generating the second signal.

3. The electronic device of claim 1, wherein the processor is configured to:
determine a similarity between the first and second signals,
determine a stationarity of the first signal based on at least part of the similarity, and
detect, when the stationarity fulfills a predetermined condition, a presence of the third signal in the first signal.

4. The electronic device of claim 3, wherein the similarity is determined based on at least one of: a chi-square value, cross correlation value, and sum of absolute difference of the first and second signals.

5. The electronic device of claim 1, wherein the processor is configured to:
determine a similarity between the first and second signal,
input the similarity to a neural network with a predetermined coefficient,
determine a stationarity of the first signal based on an output of the neural network, and
detect the third signal based on at least part of the stationarity.

6. The electronic device of claim 5, wherein the neural network comprises multiple layers, and
the processor is configured to:
control inputting the similarity to a first layer of the multiple layers, and
control inputting an output of the first layer to a second layer, the first and second layers being different from each other.

7. The electronic device of claim 3, wherein the processor is configured to determine, when the stationarity is less than a predetermined threshold, that the stationarity fulfills the predetermined condition.

8. The electronic device of claim 1, wherein the input device comprises a first input device comprising first input circuitry and a second input device comprising second input circuitry, and the processor is configured to control receiving the first signal input through an unblocked one of the first and second input devices.

9. The electronic device of claim 1, wherein the processor is configured to generate, when the third signal is detected, the fourth signal by controlling the third signal in the first signal.

10. The electronic device of claim 1, wherein the processor is configured to analyze the first and second signals in a time domain to detect the third signal.

11. A wind sound-controlled signal output method of an electronic device, the method comprising:
acquiring a first signal corresponding to external sound of the electronic device;
generating a second signal by delaying the first signal for a predetermined amount of time;
detecting a third signal corresponding to the wind sound in the first signal based on the first and second signals; and
outputting a fourth signal obtained by controlling the third signal in the first signal.

12. The method of claim 11, wherein the first signal comprises a first frame corresponding to a first time point, and generating the second signal comprises generating the second signal including a second frame corresponding to a second time point preceding the first time point.

13. The method of claim 11, wherein detecting the third signal comprises:
determining a similarity between the first and second signals;
determining a stationarity of the first signal based on at least part of the similarity; and
detecting, when the stationarity fulfills a predetermined condition, presence of the third signal in the first signal.

14. The method of claim 13, wherein the similarity is determined based on at least one of: a chi-square value, cross correlation value, and sum of absolute difference of the first and second signals.

15. The method of claim 11, wherein detecting the third signal comprises:
determining a similarity between the first and second signals;
inputting the similarity to a neural network having a predetermined coefficient;
determining a stationarity of the first signal based on an output of the neural network; and
detecting the third signal based on at least part of the stationarity.

16. The method of claim 15, wherein the neural network comprises multiple layers, and determining the stationarity of the first signal comprises:
inputting the similarity to a first layer of the multiple layers; and
inputting an output of the first layer to a second layer, the first and second layers being different from each other.

17. The method of claim 13, wherein detecting the presence of the third signal in the first signal comprises determining, when the stationarity is less than a predetermined threshold, that the stationarity fulfills the predetermined condition.

18. The method of claim 11, wherein the electronic device further comprises a first input device comprising first input circuitry and a second input device comprising second input circuitry, and acquiring the first signal comprises receiving the first signal input through an unblocked one of the first and second input devices.

19. The method of claim 11, wherein outputting the fourth signal comprises generating, when the third signal is detected, the fourth signal by controlling the third signal in the first signal.

20. A non-transitory computer readable storage medium storing a program which, when executed by a processor of an electronic device, causes the electronic device to perform operations comprising:
acquiring a first signal corresponding to external sound of an electronic device,
generating a second signal by delaying the first signal for a predetermined amount of time,
detecting a third signal corresponding to the wind sound in the first signal based on the first and second signals, and
outputting a fourth signal obtained by controlling the third signal in the first signal.
